(19) United States
(12) Patent Application Publication
(10) Pub. No.: US 2025/0065579 A1
(43) Pub. Date: Feb. 27, 2025

(54) METHOD FOR PREPARING HIGH TOUGHNESS FIBER REINFORCED POLYMER COMPOSITE

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Yunfu OU, Ningbo, Zhejiang (CN); Longqiang WU, Ningbo, Zhejiang (CN); Anran FU, Ningbo, Zhejiang (CN); Hongchen ZHAO, Ningbo, Zhejiang (CN); Yiting WENG, Ningbo, Zhejiang (CN); Dongsheng MAO, Ningbo, Zhejiang (CN)

(73) Assignee: NINGBO INSTITUTE OF MATERIALS TECHNOLOGY AND ENGINEERING, CHINESE ACADEMY OF SCIENCES, Ningbo, Zhejiang (CN)

(21) Appl. No.: 18/553,142

(22) PCT Filed: Sep. 9, 2022
(86) PCT No.: PCT/CN2022/118024

§ 371 Date: Sep. 28, 2023

(30) Foreign Application Priority Data
Sep. 5, 2022 (CN) 202211077374.4

(51) Int. Cl. B29C 71/00; B29C 70/30; B29C 70/48; B29C 70/54

(52) U.S. Cl. CPC B29C 71/0009; B29C 70/54; B29C 70/30; B29C 70/48

(57) ABSTRACT

A method for preparing a fiber composite material toughened by nano-particles, comprising: first dispersing agglomerated nano-particles uniformly in a low-viscosity, volatile dispersant by ultrasonic and micro-jet treatment (two-stage dispersion), and spraying the dispersant containing nano-particles uniformly on the fiber fabric through a high-pressure spray gun; after the liquid is removed from the fiber fabric, subjecting the nano-modified fiber fabric and resin to composite molding. The method provided by the present application is simple to operate, can be scaled up, and does not change the original manufacturing process of the fiber composite material. Moreover, the method provided by the present application requires only a very small amount of toughening components to achieve a significant increase in the interlaminar fracture toughness of the composite, which has great application prospects.

The present application claims the priority to Chinese patent application No. 202211077374.4 titled “METHOD FOR PREPARING HIGH TOUGHNESS FIBER REINFORCED POLYMER COMPOSITE”, filed with the China National Intellectual Property Administration on Sep. 5, 2022, which is incorporated herein by reference in its entirety.

### FIELD

The present application relates to the technical field of composite materials, in particular to a method for preparing a high toughness fiber reinforced polymer composite.

### BACKGROUND

With the rapid development of material science and related theories, a pursuit of higher specific strength, higher specific stiffness and higher toughness has gradually become a development direction of fiber reinforced polymer (FRP) composites. In recent decades, significant progress has been made in fiber research, for example, the mechanical properties of carbon fiber have developed from T300 to T800 and even T1000/T1100. Accordingly, an epoxy resin matrix is gradually realizing a transition from a brittle resin matrix to a tough resin matrix. However, this material is usually used in a form of a laminate. Influenced by the characteristics of its laminate structure, the load-bearing capacity of the laminate along the thickness direction is low, and the FRP structure is susceptible to delamination damage under loading conditions of in-plane compression, bending, fatigue and transverse impact. Once delamination starts and propagates inside the laminate, the stiffness of the whole structure will gradually decrease, eventually leading to catastrophic failure. Therefore, how to effectively suppress the delamination damage and improve the interlaminar fracture toughness of the composite material is a critical issue to be solved in the development and application of the FRP composites.

### SUMMARY

In view of this, an object of the embodiments according to the present application is to provide a method for preparing high toughness fiber reinforced polymer composites. The method provided by the present application is simple in process and the composite material obtained by the preparation has good properties.

A method for preparing a high toughness fiber reinforced polymer composite is provided according to the present application, which includes:
dispersing nano-particle in a solvent to obtain a nano-particle solution,
spraying the nano-particle solution on a fiber material to obtain a nano-modified fiber material; and subjecting the nano-modified fiber material and resin to composite molding to obtain a high toughness fiber reinforced polymer composite.

Preferably, the method of dispersion is a step-by-step dispersion from coarse to fine; and the method of dispersion is selected from one or more of mechanical stirring, ball milling, grinding, ultrasonic treatment, roll machine treatment, and micro-jet treatment

Preferably, the solvent is low viscosity and volatile; and the solvent is selected from one or more of water, alcohol, and acetone.

Preferably, the nano-particle is a material for reinforcement and toughening, which is selected from one or more of carbon nanotube, graphene, nanosilica, boron nitride nanotube, boron nitride nanosheet, nanoclay, carbon nanofiber, and carbon nanotube fiber. Preferably, the fiber material is selected from one or more of carbon fiber, glass fiber, basalt fiber, aramid fiber, and silicon carbide fiber.

Preferably, the resin is selected from one or more of epoxy resin, unsaturated polyester, phenolic resin, vinyl resin, bismaleimide, polyimide, nylon 6, nylon 66, polyether ether ketone, and polyether ketone ketone.

Preferably, the method of composite molding is selected from one or more of vacuum assisted resin transfer molding, resin transfer molding, hand lay-up molding, hot press tank molding, wet molding, and sheet molding compound.

Preferably, the nano-particle includes functional groups on its surface, and the functional group is selected from one or more of carboxyl, amino, and hydroxyl.

Preferably, the fiber material has a fibrous configuration selected from one or more of unidirectional, bidirectional, and three-dimensional configuration.

Preferably, the spraying is carried out using high-pressure spraying equipment.

The present application provides a simple and industrially applicable method for interlaminar toughening of a fiber composite material. On the one hand, the nano-particle can be uniformly dispersed on the fiber surface through the treatment of the step-by-step dispersion process and the impact dispersion of the high-pressure spray gun, which can improve the interface between the fiber and the resin and thus enhance the interlaminar fracture toughness of the fiber composite material. On the other hand, the treatment provided by the present application does not change the original molding process of the fiber composite material and is easy to be further promoted and applied.

### BRIEF DESCRIPTION OF THE DRAWINGS

FIG. 1 is a process flow chart for preparing a high toughness fiber reinforced polymer composite according to examples of the present application;

FIG. 2 is a scanning electron microscopy (SEM) picture of the surface of carbon nanotube-modified carbon fiber according to example 1 of the present application;

FIG. 3 is a schematic diagram of the structure of the composite material prepared according to example 1 of the present application;

FIG. 4 shows the test results of the double cantilever beam of the composite materials prepared according to example 1 and comparative example 1 of the present application;

FIG. 5 is the R-curve (curve of crack extension resistance with crack extension) of the double cantilever beam of the composite materials prepared according to example 1 and comparative example 1 of the present application;

FIG. 6 shows the test results of the end notched flexure (ENF) of the composite materials prepared according to example 1 and comparative example 1 of the present application; and

FIG. 7 is a picture of the mode I fracture surface of the composite material prepared according to example 1 of the present application.

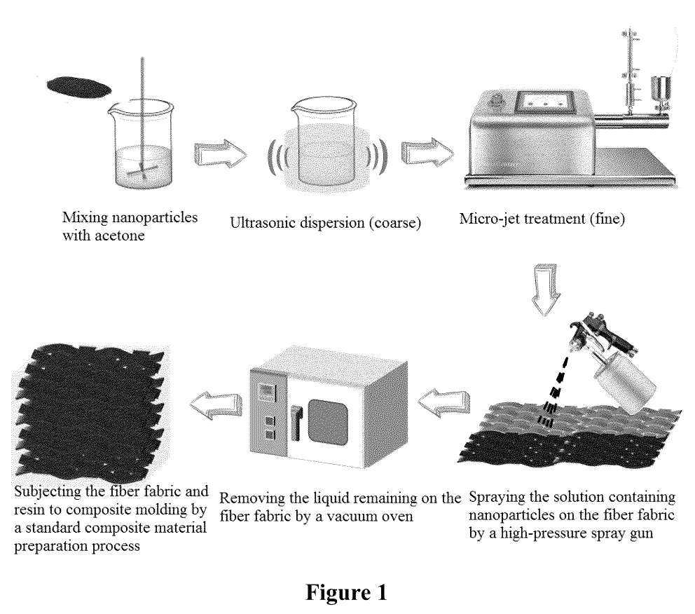

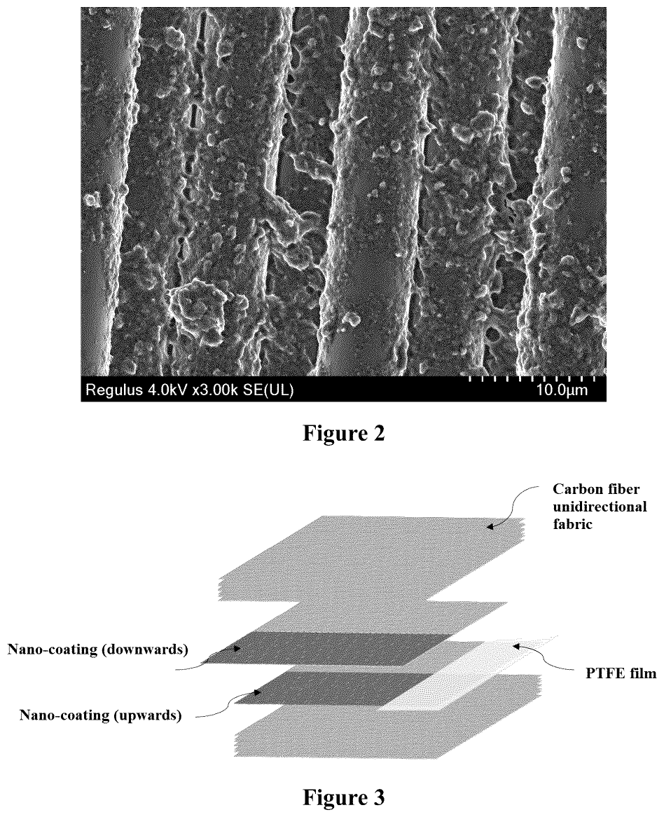

### DETAILED DESCRIPTION

The technical solutions according to embodiments of the present application are described clearly and completely hereinafter. It is clear that the described embodiments are only a part of the embodiments of the present application, rather than all embodiments. Based on the embodiments in the present application, all of other embodiments, made by the person skilled in the art without any creative efforts, fall into the scope of protection of the present application.

A method for preparing a high toughness fiber reinforced polymer composite is provided according to the present application, which includes:
dispersing nano-particle in a solvent to obtain a nano-particle solution;
spraying the nano-particle solution on a fiber material to obtain a nano-modified fiber material; and
subjecting the nano-modified fiber material and resin to composite molding to obtain a high toughness fiber reinforced polymer composite.

In the present application, the nano-particle is preferably a material for reinforcement and toughening with high performance, including but not limited to one or more of carbon nanotube, graphene, nanosilica, boron nitride nanotube, boron nitride nanosheet, nanoclay, carbon nanofiber, and carbon nanotube fiber.

In the present application, the surface of the nano-particle may or may not include a functional group, and the functional group is preferably selected from one or more of carboxyl, amino, and hydroxyl.

In the present application, the nano-particle is preferably aminated carbon nanotube, more preferably aminated multi-walled carbon nanotube; the aminated carbon nanotube has a length of preferably 0.5 μm to 2 μm; and an average length of preferably 1 μm.

In the present application, the dispersion is preferably a step-by-step dispersion from coarse to fine. In the present application, the method of dispersion is preferably selected from one or more of mechanical stirring, ball milling, grinding, ultrasonic treatment, roll machine treatment, and micro-jet treatment; and the roll machine treatment is preferably two/three roll machine treatment.

In the present application, the solvent is preferably low viscosity and volatile. In the present application, the solvent is preferably selected from one or more of water, alcohol, and acetone.

In the present application, preferably, the nano-particle is ground, then added to the solvent, and the mixture is stirred and ultrasonicated, and then dispersed by micro-jet.

In the present application, the grinding is preferably carried out in an agate mortar. The stirring is preferably carried out with a glass rod. The ultrasonic treatment is preferably carried out at room temperature. The temperature of the ultrasonic treatment is preferably 20° C. to 30° C., more preferably 25° C. The power of the ultrasonic treatment is preferably 1 kW to 5 kW (which is not consistent with the power in the examples, it is recommended to modify the two to be unified), more preferably 2 kW to 4 KW, most preferably 3 kW. The duration of the ultrasonic treatment is preferably 20 min to 40 min, more preferably 25 min to 35 min, most preferably 30 min. In the present application, the micro-jet dispersion is preferably carried out in a micro-jet high-pressure homogenizer. Preferably, acetone is used to rinse the residual nano-particle into the micro-jet device for dispersion to reduce the loss of the nano-particle. The micro-jet dispersion is preferably carried out 4 times to 8 times, more preferably 5 times to 7 times, most preferably 6 times.

In the present application, the spraying is preferably performed by high-pressure spraying equipment, such as high-pressure spray gun, for uniform spraying. During the spraying process, the spray gun is preferably connected to an air machine or nitrogen bottle, preferably an air compressor with an air purifier. During the spraying process, the spraying air pressure is preferably 0.2 MPa to 0.4 MPa, more preferably 0.3 MPa; and the spraying distance is preferably 20 cm to 40 cm, more preferably 25 cm to 35 cm, most preferably 30 cm.

In the present application, the fiber material is preferably selected from fiber fabric or fiber prepreg. In the present application, the fiber material includes, but is not limited to, one or more of carbon fiber, glass fiber, basalt fiber, aramid fiber, and silicon carbide fiber. In the present application, the fiber configuration of the fiber material includes, but is not limited to, one or more of unidirectional, bidirectional, three-dimensional configuration, etc.

In the present application, the fiber material is preferably a carbon fiber unidirectional fabric.

In the present application, after the spraying is completed, the method preferably further includes:
removing the liquid from the fiber material after being sprayed.

In the present application, the liquid removal is preferably in a vacuum oven.

In the present application, the nano-modified fiber material is preferably a fiber preform; the method of preparing the fiber preform preferably includes:
laying a multilayer fiber fabric to a fiber preform, wherein the fiber fabric includes a fiber fabric sprayed with the nano-particle solution.

In the present application, the fiber fabric is preferably a carbon fiber unidirectional fabric; the laying method is preferably hand lay-up method; the laying sequence and the laying number are stacked and arranged according to the application requirements; the method of preparing the fiber fabric sprayed with nano-particle solution is consistent with the method of spraying nano-particle solution on the fiber material as described in the above technical solution, and will not be repeated here.

In the present application, the content of nano-particles in the fiber fabric sprayed with nano-particle solution is preferably 0.1 g/m² to 0.9 g/m², more preferably 0.3 g/m² to 0.7 g/m², most preferably 0.5 g/m².

In the present application, the resin may be a thermosetting resin, such as one or more of epoxy resin, unsaturated polyester, phenolic resin, vinyl resin, bismaleimide, polyimide, etc.; and the resin may also be a thermoplastic resin, such as one or more of nylon 6, nylon 66, polyether ether ketone, polyether ketone ketone, etc.

In the present application, the method of composite molding includes, but is not limited to, one or more of vacuum assisted resin transfer molding (VARTM), resin transfer molding (RTM), hand lay-up molding, hot press tank molding, wet molding, sheet molding compound (SMC), etc.

In the present application, the composite molding preferably includes:
infusing the resin into the nano-modified fiber material, curing and molding under a certain temperature and pressure, so that the nano-particles are finally distributed in the resin matrix between the layers of the composite material.

In the present application, the method of composite molding is preferably using the VARTM method to prepare a composite material plate, which preferably includes:
introducing a resin-based slurry into the fiber preform (nano-modified fiber material); due to the pressure difference, viscosity and other factors, resin enrichment may occur at the inlet end, which will easily lead to uneven thickness of the composite material plate; to alleviate this situation, after the front end of the resin-based slurry flow reaches the outlet, closing the resin inlet first, and then closing the outlet after the excess resin is sucked out;
after the resin-based slurry is completely infused into the carbon fiber fabric (fiber preform), moving the VARTM platform as a whole into the plate vulcanizer for curing, and then cooling and demolding to obtain the composite material plate, in which the nano-particles will be finally distributed in the resin matrix between the layers of the composite material.

In the present application, the fiber preform is preferably used with a double-layer flow guide net, and the flow guide net and the fiber preform are separated by a peel ply, and finally sealed with a vacuum bag.

In the present application, the resin-based slurry is preferably an epoxy resin-based slurry. A method for preparing the resin-based slurry preferably includes:
mixing the epoxy resin and the curing agent and then degassing to obtain the resin-based slurry.

In the present application, the epoxy resin may be bisphenol A epoxy resin; the mass ratio of the epoxy resin and the curing agent is preferably 100: (20˜40), more preferably 100: (25˜36), most preferably 100:35.2; the mixing is preferably sufficient stirring; the degassing is preferably carried out in a vacuum oven; the degassing temperature is preferably 20° C. to 30° C., more preferably 25° C.; and the degassing time is preferably 8 min to 12 min, more preferably min.

In the present application, the resin-based slurry is introduced uniformly into the fiber 10 preform preferably by the negative pressure action of a vacuum pump.

In the present application, the curing preferably includes:
performing primary curing followed by secondary curing.

In the present application, the temperature of the primary curing is preferably 70° C. to 90° C., more preferably 75° C. to 85° C., most preferably 80° C.; the pressure of the primary curing is preferably 0.5 MPa to 1.5 MPa, more preferably 0.8 MPa to 1.2 MPa, most preferably 1 MPa; the duration of the primary curing is preferably 1 h to 3 h, more preferably 1.5 h to 2.5 h, most preferably 2 h; the temperature of the secondary curing is preferably 110° C. to 130° C., more preferably 115° C. to 125° C., most preferably 120° C.; the duration of the secondary curing is preferably 1 h to 3 h, more preferably 1.5 h to 2.5 h, most preferably 2 h.

The present application provides a simple and industrially applicable method for interlaminar toughening of a fiber composite material. On the one hand, the nano-particle can be uniformly dispersed on the fiber surface through the treatment of the step-by-step dispersion process and the impact dispersion of the high-pressure spray gun, which can improve the interface between the fiber and the resin and thus enhance the interlaminar fracture toughness of the fiber composite material. On the other hand, the treatment provided by the present application does not change the original molding process of the fiber composite material and is easy to be further promoted and applied.

### EXAMPLE 1

A method for preparing a carbon nanotube interlaminar toughened fiber composite material includes the following steps.

### S1. Uniformly Dispersing Carbon Nanotube in Acetone Solution

0.625 g of aminated carbon nanotubes (length ranging from 0.5 μm to 2 μm, an average value being about 1.0 μm) were weighed, then put into an agate mortar and gently ground to finely grind the large carbon nanotubes. An appropriate amount of acetone (100 g) was added, stirred using a glass rod, the mixture was sealed, and then subjected to an ultrasonic treatment of 3 KW at room temperature (25° C.) for 30 min to make the distribution of the carbon nanotubes relatively uniform. The primarily dispersed acetone solution of carbon nanotubes was dispersed using micro-jet (micro-jet high-pressure homogenizer) to break up and separate the carbon nanotubes through the interaction of the strong shear force and impact force. It should be noted that each time when dispersing, the carbon nanotubes remaining on the inner wall need to be rinsed into the micro-jet equipment with acetone for dispersion to reduce the loss of the carbon nanotubes. A total of six times of the dispersion were performed in the micro-jet equipment, so as to make the carbon nanotubes fully dispersed uniformly.

### S2. Spraying Carbon Nanotube (CNT)/Acetone Solution on Carbon Fiber Fabric

A carbon fiber unidirectional fabric (Toray T300-3000, density of 1.76 g/cm³) was taken out, 4 pieces of carbon fiber fabric of 25 cm×25 cm were cut, and the CNT/acetone solution obtained from step S1 was poured into high atomization spray gun (Japan, W-71 Siphon spray gun) respectively. The spray gun was connected to air compressor (recommended with air purifier) or nitrogen bottle, the spraying air pressure was 0.30 MPa, the spraying distance was 20 cm to 40 cm. The CNT/acetone solution was evenly sprayed on the carbon fiber fabric; and then a breathable peel ply was covered, the acetone was evaporated and the carbon fiber fabric was dried to prepare a carbon fiber fabric with 0.5 gsm (g/m² ) CNT on the surface.

### S3. Preparing Fiber Preform

Carbon fiber unidirectional fabric (Toray T300-3000, density of 1.76 g/cm³) was taken out, pieces of 25 cm×25 cm were cut, and then the fiber preform was laid by hand lay-up method. The specific method was: 16 layers of carbon fabrics were stacked and arranged in a sequence of [0°] 16, the 8th and 9th layers of the fiber fabric were covered with nano-coating on one side and arranged opposite to each other, and a 45 mm long polytetrafluoroethylene (PTFE) film (thickness of 30 μm) was laid between the layers of the carbon fiber fabrics as a pre-crack (shown in FIG. 3).

Note: In the above preparation process, the PTFE film was laid only to prepare double cantilever beam specimens for subsequent performance testing, and the PTFE film was not laid during the actual production of composite materials, i.e., the actual composite laminates did not include PTFE film.

### S4. Composite Material Plate Manufacturing

The composite material plate was prepared by VARTM method. The specific method was: the laid fiber preform was used with a double-layer flow guide net, the flow guide net and the fiber preform were separated by a peel ply, and finally sealed with a vacuum bag.

The epoxy resin-based slurry was prepared. 300 g of Bisphenol A epoxy resin Epon862 was poured into a beaker, and then 105.6 g of polyether amine curing agent (D-230, Momentive Chemical Co., Ltd.) was added and stirred thoroughly using a glass cup, and then degassed in a vacuum oven at 25° C. for 10 min to obtain about 405.6 g of resin-based slurry.

The resin-based slurry was introduced into the fiber preform by the negative pressure effect of vacuum pump. At this time, due to the pressure difference, viscosity and other factors, resin enrichment might occur at the inlet end, which would easily lead to uneven thickness of the composite material plate. To alleviate this situation, after the front end of the resin-based slurry flow reached the outlet, the resin inlet was closed first, and then the outlet was closed after the excess resin was sucked out. After the resin-based slurry was completely infused into the carbon fiber fabric, the VARTM platform as a whole was moved into the plate vulcanizer, cured at 80° C. and a pressure of 1 MPa for 2 h, then at 120° C. for 2 h; and then cooled and demolded to obtain the composite material plate, and the nano-particles would be finally distributed in the resin matrix between the layers of the composite material.

### Comparative Example 1

The composite material plate was prepared according to the method of example 1 except that steps S1 and S2 were removed and no nano-particle toughening component was added.

The fiber composite materials prepared according to example 1 as well as comparative example 1 were tested as follows.

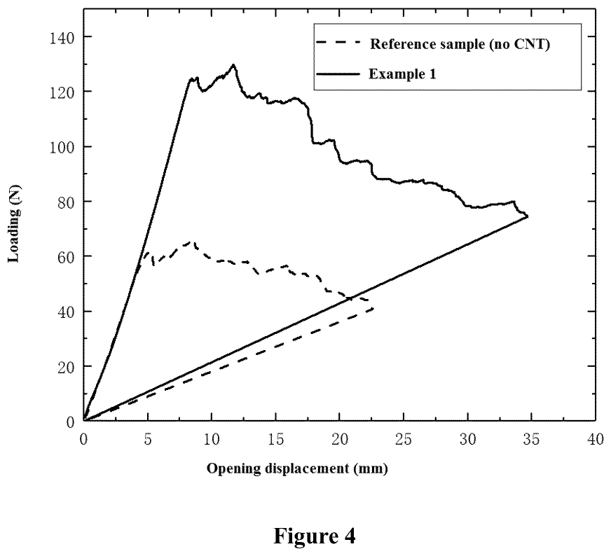

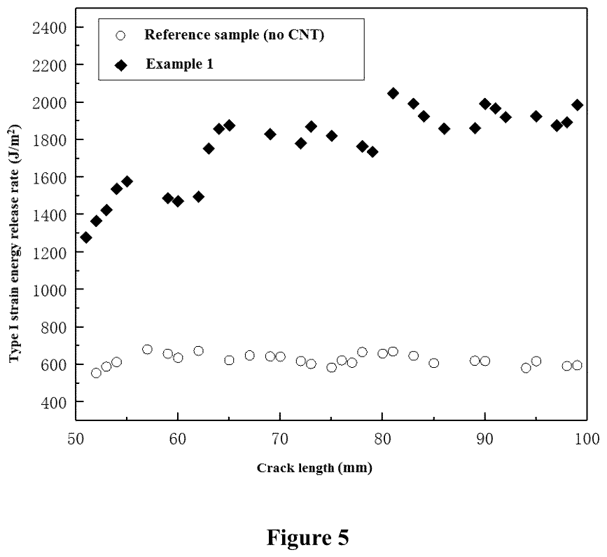

The mode I interlaminar fracture toughness was evaluated with reference to ASTM D5528. The test results were shown in FIGS. 4 and 5. FIG. 4 shows the results of the double cantilever beam test of the samples of example 1 and comparative example 1, and FIG. 5 shows the R-curve (curve of crack expansion resistance with crack expansion) of the samples of example 1 and comparative example 1. It can be seen that, compared with the reference samples of comparative example 1, the mode I interlaminar fracture toughness of the composite material plate of example 1 increased from 0.60 KJ/m² to 1.81 kJ/m², an increase of 202%.

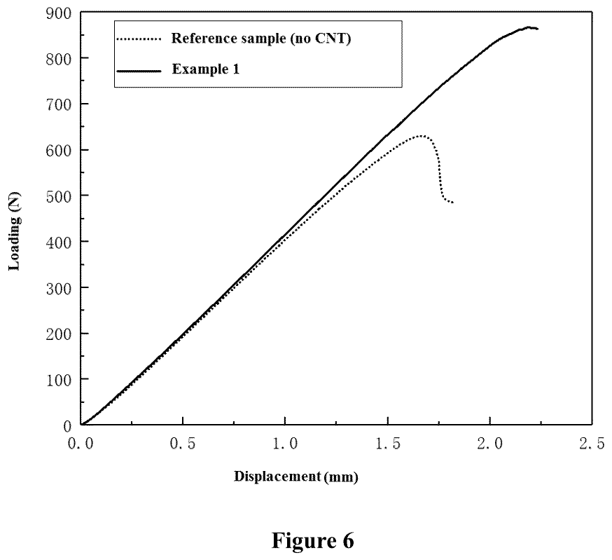

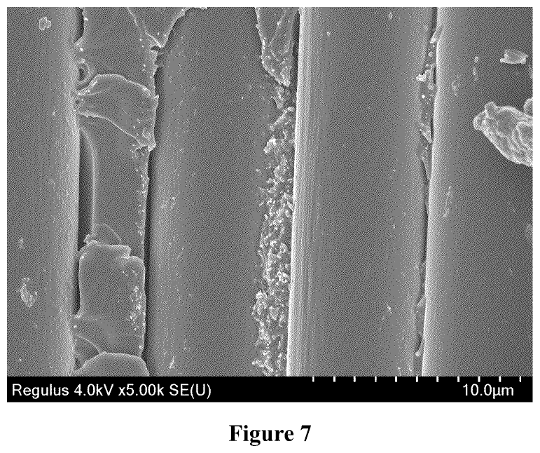

The mode II interlaminar fracture toughness was evaluated with reference to ASTM D7905. The test results were shown in FIG. 6. FIG. 6 shows the test results of the end notched flexure (ENF) of the samples of example 1 and comparative example 1. By calculation, the mode II interlaminar fracture toughness of example 1 was 0.90 kJ/m², which increased by nearly 58% compared to 0.57 kJ/m² of comparative example 1.

### EXAMPLE 2

A carbon fiber unidirectional fabric was selected and cut into 16 pieces according to the size of 250 mm×250 mm. An aminated multi-walled carbon nanotubes (length 0.5 μm to 2 μm, diameter <8 nm) were weighed according to a surface density of 1.0 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber unidirectional fabric with a spraying air pressure of 0.30 MPa and a spraying distance of 20 cm to 40 cm. A carbon fiber fabric including 1.0 gsm CNT was obtained after the acetone evaporated.

A composite material plate was prepared by VARTM. The specific method was: 16 layers of carbon fabric were stacked and arranged in a sequence of [0°] 16, the 8th and 9th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 2 was 3.8 mm, and the plate was cut into 230 mm×21 mm. Double cantilever beam (DCB) tests and end notched flexure (ENF) tests were performed respectively. It was measured that the mode I interlaminar fracture toughness (Gic) was 2.0 KJ/m² and mode II interlaminar fracture toughness (Guc) was 1.05 kJ/m².

### EXAMPLE 3

A carbon fiber unidirectional fabric was selected and cut into 16 pieces according to the size of 250 mm×250 mm. An aminated multi-walled carbon nanotubes (length 0.5 μm to 2 μm, diameter <8 nm) were weighed according to a surface density of 1.5 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber unidirectional fabric with a spraying air pressure of 0.30 MPa and a spraying distance of 20 cm to 40 cm. A carbon fiber fabric including 1.5 gsm CNT was obtained after the acetone evaporated.

A composite material plate was prepared by VARTM. The specific method was: 16 layers of carbon fabric were stacked and arranged in a sequence of [0°] 16, the 8th and 9th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 3 was 3.8 mm, and the plate was cut into 230 mm×21 mm. Double cantilever beam (DCB) tests and end notched flexure (ENF) tests were performed respectively. It was measured that the mode I interlaminar fracture toughness (Gic) was 1.3 kJ/m² and mode II interlaminar fracture toughness (Guc) was 0.76 kJ/m².

### EXAMPLE 4

A carbon fiber bidirectional fabric was selected and cut into 20 pieces according to the size of 250 mm×250 mm. An aminated multi-walled carbon nanotubes (length 0.5 μm to 2 μm, diameter <8 nm) were weighed according to a surface density of 1.0 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber bidirectional fabric with a spraying air pressure of 0.30 MPa and a spraying distance of 20 cm to 40 cm. A carbon fiber fabric including 1.0 gsm CNT was obtained after the acetone evaporated.

A composite material plate was prepared by VARTM. The specific method was: 20 layers of carbon fabric were stacked and arranged in a sequence of [0°] 20, the 10th and 11th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 4 was 3.6 mm, and the plate was cut into 230 mm×21 mm. Double cantilever beam (DCB) tests and end notched flexure (ENF) tests were performed respectively. It was measured that the mode I interlaminar fracture toughness (Gic) was 1.3 kJ/m² and mode II interlaminar fracture toughness (Guc) was 1.42 kJ/m².

### EXAMPLE 5

A carbon fiber bidirectional fabric was selected and cut into 20 pieces according to the size of 250 mm×250 mm. An aminated multi-walled carbon nanotubes (length 0.5 μm to 2 μm, diameter <8 nm) were weighed according to a surface density of 2.0 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber bidirectional fabric with a spraying air pressure of 0.30 MPa and a spraying distance of 20 cm to 40 cm. A carbon fiber fabric including 2.0 gsm CNT was obtained after the acetone evaporated.

A composite material plate was prepared by VARTM. The specific method was: 20 layers of carbon fabric were stacked and arranged in a sequence of [0°] 20, the 10th and 11th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 5 was 3.6 mm, and the plate was cut into 230 mm×21 mm. Double cantilever beam (DCB) tests and end notched flexure (ENF) tests were performed respectively. It was measured that the mode I interlaminar fracture toughness (Gic) was 1.0 kJ/m² and mode II interlaminar fracture toughness (Guc) was 1.63 kJ/m².

### EXAMPLE 6

A carbon fiber bidirectional fabric was selected and cut into 20 pieces according to the size of 250 mm×250 mm. An aminated multi-walled carbon nanotubes (length 0.5 μm to 2 μm, diameter <8 nm) were weighed according to a surface density of 3.0 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber bidirectional fabric with a spraying air pressure of 0.30 MPa and a spraying distance of 20 cm to 40 cm. A carbon fiber fabric including 3.0 gsm

CNT was obtained after the acetone evaporated.

A composite material plate was prepared by VARTM. The specific method was: 20 layers of carbon fabric were stacked and arranged in a sequence of [0°] 20, the 10th and 11th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 6 was 3.6 mm, and the plate was cut into 230 mm×21 mm. Double cantilever beam (DCB) tests and end notched flexure (ENF) tests were performed respectively. It was measured that the mode I interlaminar fracture toughness (Gic) was 1.3 kJ/m² and mode II interlaminar fracture toughness (Guc) was 1.53 KJ/m².

### EXAMPLE 7

A carbon fiber bidirectional fabric was selected and cut into 20 pieces according to the size of 250 mm×250 mm. An aminated multi-walled carbon nanotubes (length 0.5 μm to 2 μm, diameter <8 nm) were weighed according to a surface density of 4.0 gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the carbon fiber bidirectional fabric with a spraying air pressure of 0.30 MPa and a spraying distance of 20 cm to 40 cm. A carbon fiber fabric including 4.0 gsm CNT was obtained after the acetone evaporated.

A composite material plate was prepared by VARTM. The specific method was: 20 layers of carbon fabric were stacked and arranged in a sequence of [0°] 20, the 10th and 11th layers of the fiber fabric were covered with nano-coating on one side and arranged opposite to each other, and a 45 mm long polytetrafluoroethylene film (thickness of 30 μm) was laid between the layers of the carbon fiber fabrics as a pre-crack.

Bisphenol A epoxy resin Epon862 was selected, and curing agent D-230 was added (the mass ratio of the two was 100:35.2). After stirring uniformly and degassing, the resin slurry was introduced into the fiber preform using a vacuum pump, and finally pressed and cured on a plate vulcanizer under pressure of 1 MPa according to the curing process of 80° C./2 h+120° C./2 h.

The thickness of the pressed plate according to example 7 was 3.6 mm, and the plate was cut into 230 mm×21 mm. Double cantilever beam (DCB) tests and end notched flexure (ENF) tests were performed respectively. It was measured that the mode I interlaminar fracture toughness (Gic) was 1.0 KJ/m² and mode II interlaminar fracture toughness (Guc) was 1.7 KJ/m².

### EXAMPLE 8

A glass fiber bidirectional fabric was selected and cut into 30 pieces according to the size of 250 mm×250 mm. An aminated multi-walled carbon nanotubes (length 0.5 μm to 2 μm, diameter<8nm) were weighed according to a surface density of 0.5gsm, ground and ultrasonicated in acetone for 30 min. The CNT/acetone solution was dispersed six times by a micro-jet high-pressure homogenizer.

The dispersed CNT/acetone solution was poured into a high atomization spray gun and sprayed uniformly on the glass fiber bidirectional fabric with a spraying air pressure of 0.30 MPa and a spraying distance of 20 cm to 40 cm. A glass fiber fabric including 0.5 gsm CNT was obtained after the acetone evaporated.

A composite material plate was prepared by VARTM. The specific method was: 30 layers of glass fiber fabrics were stacked and arranged in a sequence of [0°] 30, the 15th and 16th layers of the glass fiber fabric were covered with nano-coating on one side and arranged opposite to each other, and a 45 mm long polytetrafluoroethylene film (thickness of 30 μm) was laid between the layers of the glass fiber fabrics as a pre-crack.

Epoxy resin R-0221A (Qirui Chemical) was selected, and curing agent R-0221B (Qirui Chemical) was added (the mass ratio of the two was 100:25). After stirring uniformly and degassing, the resin slurry was introduced into the fiber preform using a vacuum pump, and finally pressed and cured on a plate vulcanizer under pressure of 1 MPa according to the curing process of 85° C./2 h.

The thickness of the pressed plate according to example 8 was 5.3 mm, and the plate was cut into 230 mm×21 mm. Double cantilever beam (DCB) tests and end notched flexure (ENF) tests were performed respectively. It was measured that the mode I interlaminar fracture toughness (Gic) was 1.31 kJ/m² and mode II interlaminar fracture toughness (Guc) was 0.69 kJ/m².

The present application provides a simple and industrially applicable method for interlaminar toughening of a fiber composite material. On the one hand, the nano-particle can be uniformly dispersed on the fiber surface through the treatment of the step-by-step dispersion process and the impact dispersion of the high-pressure spray gun, which can improve the interface between the fiber and the resin and thus enhance the interlaminar fracture toughness of the fiber composite material. On the other hand, the treatment provided by the present application does not change the original molding process of the fiber composite material and is easy to be further promoted and applied.

The above described are only preferred embodiments of the present application. It should be noted that, for the ordinary skilled person in the art, several improvements and refinements can be made without departing from the principle of the present application, and these improvements and refinements should also be considered as the scope of protection of the present application.

1. A method for preparing a high toughness fiber reinforced polymer composite, comprising:
dispersing nano-particle in a solvent to obtain a nano-particle solution,
spraying the nano-particle solution on a fiber material to obtain a nano-modified fiber material; and
subjecting the nano-modified fiber material and resin to composite molding to obtain a high toughness fiber reinforced polymer composite.

2. The method according to claim 1, wherein the method of dispersion is a step-by-step dispersion from coarse to fine; and
the method of dispersion is selected from one or more of mechanical stirring, ball milling, grinding, ultrasonic treatment, roll machine treatment, and micro-jet treatment.

3. The method according to claim 1, wherein the solvent is low viscosity and volatile; and
the solvent is selected from one or more of water, alcohol, and acetone.

4. The method according to claim 1, wherein the nano-particle is a material for reinforcement and toughening, which is selected from one or more of carbon nanotube, graphene, nanosilica, boron nitride nanotube, boron nitride nanosheet, nanoclay, carbon nanofiber, and carbon nanotube fiber.

5. The method according to claim 1, wherein the fiber material is selected from one or more of carbon fiber, glass fiber, basalt fiber, aramid fiber, and silicon carbide fiber.

6. The method according to claim 1, wherein the resin is selected from one or more of epoxy resin, unsaturated polyester, phenolic resin, vinyl resin, bismaleimide, polyimide, nylon 6, nylon 66, polyether ether ketone, and polyether ketone ketone.

7. The method according to claim 1, wherein the method of composite molding is selected from one or more of vacuum assisted resin transfer molding, resin transfer molding, hand lay-up molding, hot press tank molding, wet molding, and sheet molding compound.

8. The method according to claim 1, wherein the nano-particle comprises a functional group on its surface, and the functional group is selected from one or more of carboxyl, amino, and hydroxyl.

9. The method according to claim 1, wherein the fiber material has a fibrous configuration selected from one or more of unidirectional, bidirectional, and three-dimensional configuration.

10. The method according to claim 1, wherein the spraying is carried out using high-pressure spraying equipment.
